(19) United States
(12) Patent Application Publication
(10) Pub. No.: US 2023/0359539 A1
(43) Pub. Date: Nov. 9, 2023

(54) IMPROVED SOFTWARE MONITORING OF REAL-TIME SERVICES

(71) Applicant: Telefonaktiebolaget LM Ericsson (PUBL), Stockholm (SE)

(72) Inventors: Patrik Åberg, SÖDRA SANDBY (SE); Victor Millnert, MALMÖ (SE)

(21) Appl. No.: 18/004,921

(22) PCT Filed: Jul. 17, 2020
(86) PCT No.: PCT/EP2020/070253

§ 371 Date: Jan. 10, 2023

(51) Int. Cl. G06F 11/34; G06V 10/82; G06F 11/32

(52) U.S. Cl. CPC G06F 11/3409; G06V 10/82; G06F 11/32

(57) ABSTRACT

A software monitoring of real-time services arrangement (100) comprising a controller (101) configured to: receive (310) data relating to real-time performance (211) from one or more real-time services (215), the data relating to real-time performance (211) indicates a performance of the real-time services (215); generate (330) a performance image (245) wherein the data relating to real-time performance (211) for an associated real-time services (215) indicates an image characteristic in an area of the performance image (245) corresponding to the associated real-time services (215); perform (340) image analysis (250) on the performance image (245); and select (350) an action for achieving a desired result based on the image analysis.

### TECHNICAL FIELD

The present invention relates to an arrangement, an arrangement comprising computer software modules, an arrangement comprising circuits, a device and a method for providing an improved manner of software monitoring of real-time services, and in particular to an arrangement, an arrangement comprising computer software modules, an arrangement comprising circuits, a device and a method for providing an improved manner of software monitoring using neural networks.

### BACKGROUND

As computers grow in processing power, so does the number of and variety of applications where computers are utilized. This is apparent in automatization of various processes where various processes are performed by computer-control. One example field is the internet of things (IoT), where several devices are connected to perform automated processes and in real-time. As with all processes, they need to be monitored and it is a complicated task to develop a software surveillance system that can detect when a real-time service (RTS) is about to violate some of its real-time requirements, especially when the RTS is deployed on top of a virtualized environment and is connected to other real-time services. In such systems, the requirements for guaranteeing that no real-time requirements are violated are constantly changing over time and depend on a diverse set of external and internal factors (e.g., CPU usage, memory usage, traffic load, characteristics of the virtualization environment, the physical hardware, internal states of the RTS, other application executing in the same environment, etc.), where a small change in one aspect can have a significant impact in another aspect of the system.

The state-of-the-art solutions for providing such monitoring involves developing mechanistic models, both statistical and dynamic ones, which allow a system to predict the performance of the real-time services given these factors, and thereby predict when a violation of a real-time requirement might occur. For instance, such a model might take as input the CPU load, the memory usage, and the rate by which traffic is entering the service in order to predict the processing capacity of the node, and in turn predict whether any violation of a real-time requirement might occur.

These models would then be used in conjunction with a control unit which decides whether to change some parameters or functionality of the real-time services, in order to affect its real-time performance and thereby mitigate a risk of violating a real-time requirement.

One example is disclosed in the patent application published as US2020014594-A1 which discloses a system where a network of virtual network functions can be adapted based on for example user behavior where data is collected and analyzed to provide for such adaptation. The data is collected in real-time, i.e. as the adaptation is to be performed, but the data itself may be older or static data and need not be an indication of a real-time performance. As such, that system is unable to detect such small changes in one aspect that may affect another aspect in a significant manner. As in that system, contemporary networks of real-time services can be huge, wherein the usually simple step of collecting the data is no longer a simple.

Even for a single real-time service (RTS) the approach of developing mechanistic models to predict its performance is a very complicated task, since the real-time performance (RTP) depends on a myriad of metrics, such as CPU usage, memory usage, disk access, I/O access, as well as the type of service being provides, and the traffic it handles etc. On top of this the RTP also depend on things like which physical hardware it is deployed on, and whether there is a virtualization layer, and if so, of which type it is. In the case of a virtualization layer below the RTS, the RTP can also depend on which other service are being run on the same physical hardware.

Expand the system to be a network of RTSs and the complexity quickly grows out of hand. Different RTS will then affect each other. For instance, an increase in CPU usage of Service A, might lead to an increase of disk access of Service D, which in turn will lead to a violation of the real-time requirements of Service B.

This method does therefore not scale very well, since it has to be tailored to each use-case and for each service.

Another downside of using the tailored approach is that one may have to redo the extensive modeling process after a patch or update to the services. In some cases, a patch to service B could even lead to a need to update the model of service C.

Finally, when the system grows it will also be intractable to collect and analyze all the data which is required to use these models. With limited processing “extra” processing power at the services, this data has to be transported overt the network, which also becomes unfeasible.

There is thus a need for a more efficient manner of both providing software monitoring of real-time systems and for analyzing the result of such monitoring.

### SUMMARY

The inventors have realized that an automation of the monitoring of the real-time services would indeed be beneficial to both software monitoring and of the analysis of such monitoring. The inventors have also realized that as the monitoring is to be automated, the exact nature of the real-time data to be collected need not be readable to a human monitor and the inventors further realized that by insightfully changing the very nature of the data produced, other than the traditional analysis tools may be utilized. As will be shown below, this has provided an extremely simple and elegant manner for providing automated monitoring and the analysis of the monitoring.

The inventors have further realized that traditional analysis tools are not advanced enough to handle the sizes of real-time service systems, which may be vast indeed, especially if implemented as cloud services. The inventors have therefore realized that the most advanced analysis tools available are aimed at image analysis, and are thus proposing to insightfully produce an image as the output of the monitoring, which image may be analyzed using image analysis tools, such as the many various neural network tools and techniques commonly used for image analysis, for example through the use of Convoluted Neural Networks (CNN).

An object of the present teachings is therefore to overcome or at least reduce or mitigate the problems discussed, by providing a manner of providing monitoring by generating a visual or image log file which is analyzed using image analysis tools thereby taking advantage of the highly advanced technology available for image analysis.

According to one aspect a software monitoring of real-time services arrangement is provided, the software monitoring of real-time services arrangement comprises a controller configured to receive data relating to real-time performance from one or more real-time services, the data relating to real-time performance indicates a performance of the real-time services, generate a performance image wherein the data relating to real-time performance for an associated real-time services indicates an image characteristic in an area of the performance image corresponding to the associated real-time services, perform image analysis on the performance image, and select an action for achieving a desired result based on the image analysis.

The solution may be implemented as a software solution, a hardware solution or a mix of software and hardware components.

In one embodiment the image analysis is based on a neural network.

In one embodiment the controller is further configured to train the image analysis.

In one embodiment the controller is further configured to transmit one or more commands to one or more of the real-time services, wherein the one or more commands relate to the selected action and wherein the one or more commands provides the action when executed by the one or more of the real-time services.

In one embodiment the performance image is a series of images thereby providing an image analysis over time.

In one embodiment the performance image comprises a dimension representing time thereby providing an image analysis over time.

In one embodiment the controller is further configured to receive the data relating to real-time performance in a simplified form, whereby the simplified form is a uniform representation of performance for all real-time services.

In one embodiment the controller is further configured to perform image analysis on the performance image to detect a pattern, wherein the action for achieving a desired result based on the image analysis is associated with the detected pattern.

In one embodiment the image analysis is based on object detection for detecting the pattern.

In one embodiment the object detection is based on a Deep Neural Network model.

In one embodiment the controller is further configured to receive the data relating to real-time performance through a message communication bus.

According to one aspect a method for use in a software monitoring of real-time services arrangement is provided, the method being for providing software monitoring of real-time services as taught herein. The method comprises receiving data relating to real-time performance from one or more real-time services, the data relating to real-time performance indicates a performance of the real-time services, generating a performance image wherein the data relating to real-time performance for an associated real-time services indicates an image characteristic in an area of the performance image corresponding to the associated real-time services, performing image analysis on the performance image, and selecting an action for achieving a desired result based on the image analysis.

According to one aspect there is provided a computer-readable medium carrying computer instructions that when loaded into and executed by a controller of a software monitoring of real-time services arrangement enables the software monitoring of real-time services arrangement to implement a method according to herein.

According to one aspect there is provided a software component (or module) arrangement according to an embodiment of the teachings herein. The software component arrangement is adapted to be used in a software monitoring of real-time services arrangement as taught herein for automated software monitoring of real-time services as taught herein.

The software component arrangement comprises a software component for receiving data relating to real-time performance from one or more real-time services, the data relating to real-time performance indicates a performance of the real-time services.

The software component arrangement also comprises a software component for generating a performance image wherein the data relating to real-time performance for an associated real-time services indicates an image characteristic in an area of the performance image corresponding to the associated real-time services, a software component for performing image analysis on the performance image, and a software component for selecting an action for achieving a desired result based on the image analysis.

According to one aspect there is provided an arrangement comprising circuitry for software monitoring of real-time services according to an embodiment of the teachings herein. The arrangement comprising circuitry for software monitoring of real-time services is adapted to be used in a software monitoring of real-time services arrangement as taught herein for automated software monitoring of real-time services.

The arrangement comprising circuitry for software monitoring of real-time services comprises circuitry for

The arrangement comprising circuitry for software monitoring of real-time services also comprises circuitry for receiving data relating to real-time performance from one or more real-time services, the data relating to real-time performance indicates a performance of the real-time services. The arrangement comprising circuitry for automated software monitoring of real-time services also comprises a circuitry for generating a performance image wherein the data relating to real-time performance for an associated real-time services indicates an image characteristic in an area of the performance image corresponding to the associated real-time services, circuitry for performing image analysis on the performance image, and circuitry for selecting an action for achieving a desired result based on the image analysis.

The teachings herein finds use both within and outside a cloud environment. One intended target use-case is for a real-time cloud; however the teachings herein may equally well be used in a closed multi-service environment deployed on local stand-alone hardware. One example could be the infotainment system in autonomous cars, or actuators and sensors in a manufacturing plant.

Further embodiments and advantages of the present invention will be given in the detailed description. It should be noted that the teachings herein find use in monitoring arrangements in many areas of software monitoring of real-time service systems.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a software monitoring of real-time services arrangement according to an embodiment of the present invention;

FIG. 1B shows a schematic view of a software monitoring of real-time services arrangement according to an embodiment of the present invention;

FIG. 2 shows a schematic view of a software monitoring of real-time services system according to one embodiment of the teachings herein;

FIG. 3 shows a flowchart of a general method according to an embodiment of the present invention;

FIG. 4 shows a component view for a software component arrangement according to an embodiment of the teachings herein;

FIG. 5 shows a component view for an arrangement comprising circuits according to an embodiment of the teachings herein; and

FIG. 6 shows a schematic view of a computer-readable medium carrying computer instructions that when loaded into and executed by a controller of an arrangement enables the arrangement to implement an embodiment of the present invention.

### DETAILED DESCRIPTION

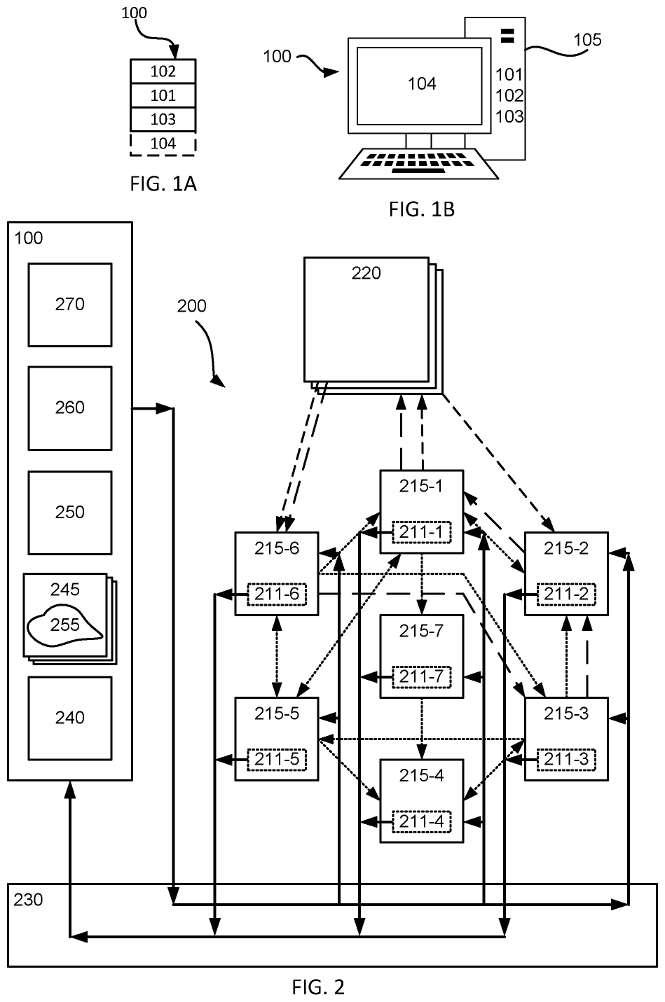

FIG. 1A shows a schematic view of a software monitoring of real-time services arrangement 100 according to an embodiment of the present invention. The software monitoring of real-time services arrangement 100 comprises a controller 101 and a memory 102. It should be noted that the software monitoring of real-time services arrangement 100 may comprise a single device, such as a server, or may be distributed across several devices and apparatuses.

The controller 101 is configured to control the overall operation of the software monitoring of real-time services arrangement 100. In one embodiment, the controller 101 is a general purpose processor. In one embodiment, the controller 101 is a combination of a graphics controller and a general purpose controller. As a skilled person would understand there are many alternatives for how to implement a controller, such as using Field-Programmable Gate Arrays circuits, AISIC, GPU, etc. in addition or as an alternative. For the purpose of this application, all such possibilities and alternatives will be referred to simply as the controller 101.

The memory 102 is configured to store data and computer-readable instructions that when loaded into the controller 101 indicates how the software monitoring of real-time services arrangement 100 is to be controlled. The memory 102 may comprise one or several memory modules, partitions, allocations, units or devices, but they will be perceived as being part of the same overall memory 102. There may be one memory unit for storing data, one memory for the communications interface (see below) for storing settings, and so on. As a skilled person would understand there are many possibilities of how to select where data should be stored and a general memory 102 for the software monitoring of real-time services arrangement 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. The memory 102 may also be an allocation of a larger memory partition. For the purpose of this application all such alternatives will be referred to simply as the memory 102.

In one embodiment the software monitoring of real-time services arrangement 100 further comprises a communication interface 103. The communication interface may be wired and/or wireless. The communication interface may comprise several interfaces.

In one embodiment the communication interface comprises a USB (Universal Serial Bus) interface. In one embodiment the communication interface comprises an analog interface, a CAN (Controller Area Network) bus interface, an I2C (Inter-Integrated Circuit) interface, or other interface.

In one embodiment the communication interface comprises a radio frequency (RF) communications interface. In one such embodiment the communication interface comprises a Bluetooth™ interface, a WiFi™ interface, a ZigBee™ interface, a REID™ (Radio Frequency IDentifier) interface, Wireless Display (WiDi) interface, Miracast interface, and/or other RF interface commonly used for short range RF communication. In an alternative or supplemental such embodiment the communication interface comprises a cellular communications interface such as a fifth generation (5G) cellular communication interface, an LTE (Long Term Evolution) interface, a GSM (Global Systéme Mobilé) interface and/or other interface commonly used for cellular communication. In one embodiment the communications interface is configured to communicate using the UPnP (Universal Plug n Play) protocol. In one embodiment the communications interface is configured to communicate using the DLNA (Digital Living Network Appliance) protocol.

In one embodiment, the communications interface 103 is configured to enable communication through more than one of the example technologies given above.

The communications interface 103 may be configured to enable the software monitoring of real-time services arrangement 100 to communicate with devices that are part of the real-time services for receiving data on real-time performance from such real-time services.

A user interface 104 may be comprised in the software monitoring of real-time services arrangement 100. Additionally or alternatively, (at least a part of) the user interface 104 may be comprised remotely in the software monitoring of real-time services arrangement 100 through the communication interface 103, the user interface 104 then (at least a part of it) not being a physical means in the software monitoring of real-time services arrangement 100, but implemented by receiving user input or providing user output through a remote device (not shown) through the communication interface 103. Examples of such a remote device are a mobile phone handset, a tablet computer or a computer.

FIG. 1B shows a schematic view of one such example of a software monitoring of real-time services arrangement 100 according to an embodiment of the present invention. The software monitoring of real-time services arrangement 100 in this example is a desktop computer or work station 100 comprising a housing 105 in which the controller 101, the memory 102 and the communication interface 103 is housed. The work station is in this example also provided with a user interface 104 comprising a display and a keyboard. The work station is, in one embodiment, a representation of a service to be executed on one or more servers.

In the following the software monitoring of real-time services arrangement 100 will also be referred to simply as the monitoring arrangement 100.

FIG. 2 shows a schematic view of a software monitoring of real-time services system 200 comprising a software monitoring of real-time services arrangement 100 according to one embodiment of the teachings herein and a plurality of real-time services 215 to be monitored. In this example the real-time services 215-1-215-7 are shown to be seven (7), but it should be apparent that this (low) number is only for illustrative purposes and in a real-world example, the number of real-time services 215 is much higher. The real-time services 215 may be connected for sharing data, for cooperating on a task or to be part of a process flow, to mention a few reasons why the real-time services 215 are connected, as indicated by the dotted arrows. As is also shown in FIG. 2, there may be one or more high-level applications 220 that utilize one or more of the real-time services 215. The high-level applications 220 may provide control input, data input or other input to the real-time services 215 and/or receive output from the real-time services 215 as indicated by the dashed arrows. The exact nature of the high-level applications 220 and the real-time services 215 is not essential to the teachings herein, which may be applied to a great variety of real-time service systems and will therefore not be discussed in further detail, except that one high-level application 220 may provide input to one real-time services 215 while another high-level application 220 receives output from another real-time services 215 that is based on data received from the first real-time service possibly adapted through other real-time services 215. One example of this complicated interconnection between high-level applications 220 and real-time services 215 is illustrated with the double—spaced dashed line going from one high-level application to the sixth real-time services 215-6, being forwarded to the third real-time services 215-3, the second real-time services 215-2 and the first real-time services 215-1 respectively before the output is received by another high-level application 220. As would be understood, it would—using traditional monitoring—be very difficult to realize where an error has occurred in such a complicated chain if only an error in the output was detected.

Each real-time services 215 is arranged to collect data 211 representing one or more performance metrics, reflecting a real-time performance of the real-time services 215.

The real-time performance data 211 of the real-time services 215 may relate to how well a time limit for executing a process is met, the degree of the output generated by the real-time services 215, or any other metric representing the performance of the REAL-TIME SERVICES 215. The real-time performance data 211 may relate to bandwidth and latency requirements for any service using any protocol at any level, such as slack for meting specific target deadlines, available capacity to handle additional load, jitter to mention a few more examples.

The real-time performance data 211 is communicated to the monitoring arrangement 100 in a simplified form indicating a single value representing the real-time performance. In one embodiment, the single value may be a value in the range 0 to 1, where 0 denotes a failed or bad performance and 1 denotes a perfect or good performance. The exact type of the simplified form is not essential, but all real-time services 215 utilize the same simplified form.

Also part of the system 200 is a communication channel 230 through which the real-time performance data 211 is communicated to the monitoring arrangement 100 as indicated by the thick lines in FIG. 2. The communication channel 230 may be implemented as one or more Application Programming Interfaces (API) utilizing an existing communication platform, such as provided by the communication interface 103. The communication channel 230 is in one embodiment implemented as a message bus. Such message buses are known in the art, and require no further detail, especially since there are many variations available and to describe them all would place an undue burden on both the author as well as the reader of the present application. Suffice to state that utilizing a message bus enables for the real-time services 215 to provide the real-time performance data 211 at will, wherein a communication of the real-time performance data 211 is achieved using only a minimum of resources, i.e having a low foot print, performance and processing power-wise.

By measuring the real-time performance of the cloud services as a metric between 0 and 1, the monitoring arrangement 100 is enabled to collect dense data with a low footprint. It also allows each unique service developer to define themselves what a “good” real-time performance means (which could be very different for example for a eCIPRI-service compared to a robotic arm).

Also, by having a standardized “control-interface” implemented in one embodiment as an Application Program Interface (API) we allow developers of each service to themselves define how to change their real-time performance (which is unique for each service).

And, by having the communication go over a message bus a low-footprint communication between the central and distributed units is provided.

The monitoring arrangement 100 is therefore configured to receive the real-time performance data 211 from all or at least some of the real-time services 215. Each real-time services 215 is assigned a channel in the monitoring arrangement 100 and the real-time performance data 211 received for the corresponding real-time services 215 is interpreted by the monitoring arrangement 100 as an intensity for that channel, i.e the corresponding real-time services 215. The monitoring arrangement 100 is arranged to execute an image generator 240 that generates a data collection, hereafter referred to as a performance image 245. It should be noted that the performance image 245 may not be an image that is perceivable to a human, but is a data collection that is to be processed as an image by the monitoring arrangement 100.

Each channel, i.e. each real-time services 215 for which real-time performance data 211 is received, corresponds to an area in the performance image 245. In one embodiment, the area corresponds to one pixel. In one embodiment, the area corresponds to a group of pixels. In one embodiment, the area corresponds to a color channel of one or more pixels.

The real-time performance data 211 indicates a characteristic for the corresponding area, and a pattern 255 will thereby be generated in the performance image 245. Again, the pattern 255 may not be visible to a human observer. The characteristic for the corresponding area may indicate a color scale, an intensity, a brightness or other image characteristic.

As the real-time performance data 211 is also collected in real-time representing one instance in the execution of the real-time services 215, the generated performance image 245 provides a snap shot of the overall execution of the system of the real-time services 215, where the pattern 255 represents the performance at the relevant instance. By taking snapshots of the real-time performance a dense image is generated which is rich with information about the performance of the services.

Also, by representing the snapshot-data as an image we are able to use the latest machine-learning frameworks, such as a convolutional neural network as will be discussed below.

The monitoring arrangement 100 is also arranged to perform an analysis 250 of the performance image 245. As discussed above, contemporary image analysis tools are highly advanced and able to recognize many different objects and also take into account slight changes or differences in such objects. The inventors are therefore proposing to perform the analysis of the monitoring based on an image analysis 250 of the performance image 245. In one such embodiment, the image analysis 250 is based on neural networks, for example image analysis methods based on deep learning methods, for example CNNs. The image analysis 250 may be trained on recognizing several different states of the system of real-time services 215, where each state is represented by an image object or (part of) a pattern 255. The image analysis 250 will then be able to detect a specific state as a specific object, and forward this detection to a command unit 260 of the monitoring arrangement 100.

By using a convolutional neural network to predict future performance, the convolutional neural network may be used to predict what the image will look like in the near future, and thereby predict what the real-time performance will be for the different services in the near future.

The monitoring arrangement 100 is arranged to select an appropriate action by the command unit 260 receiving the detected one or more objects or states represented by patterns 255 and pairing the detected one or more objects with a corresponding action. This enables for a prediction of future performances of the real-time services 215.

By associating various actions to different states of the system of real-time services 215, a detailed control response is enabled to be provided by the monitoring arrangement 100, simply based on analyzing the real-time performance data 211 as an image, wherein detection of a pattern 255 in the image 245 by the image analysis tool 250 may be used to predict a future performance of the real-time services 215, which may be associated with an action to be taken. In response to this the monitoring arrangement 100 selects one or more commands to be executed by corresponding real-time services 215.

The monitoring arrangement 100 is further arranged to provide the one or more commands relating to the action to the corresponding real-time services 215 through the command unit 260 and the communication channel 230 as indicated by the outgoing thick lines in FIG. 2.

By analyzing a series of images 245, i.e. to analyze the performance over time, the image analysis 250 may be utilized to detect patterns in time indicating a sequence of events that may need some correction through an associated action. Such correlations are highly complex to quantify in traditional systems, but are easy to detect using state-of-the-art image analysis tools as the inventors have realized.

As the inventors have also realized, since the performance image 245 need not be visible, the time aspect may be represented through an additional dimension in the performance image 245. This provides an alternative to analyzing a series of images. In such an embodiment, there may be a limit to the number of time instances that are represented in the image by limiting the extension in the time dimension.

The monitoring arrangement 100 is therefore in one embodiment arranged to update the performance image 215 or to generate a new performance image based on subsequently received real-time performance data 211.

In one embodiment, the monitoring arrangement 100 is arranged to receive the real-time performance data at an instance in time. In one alternative or additional embodiment, the monitoring arrangement 100 is arranged to receive the real-time performance data at a regular instances in time. In one alternative or additional embodiment, the monitoring arrangement 100 is arranged to receive the real-time performance data at a repeated instances in time initiated by one or several of the real-time services 215.

In one embodiment, one first image 245 may be utilized to represent a time-aspect of the system of real-time services 215, while a second image 245 may be utilized to represent a second time-aspect of the system of real-time services 215 for detecting for example both fast processes or flows in the system of real-time services 215 and slow processes or flows in the system of real-time services 215.

To save on memory, the monitoring arrangement is in one embodiment arranged to only update the performance image or generate a new instance of the performance image 245 when a change in the real-time performance data 211 is detected.

It should be repeated that the monitoring arrangement need not be arranged as a single device but may comprise or be distributed onto several devices, possibly as part of a cloud service, wherein the software monitoring of real-time services is arranged to be executed by several controllers 101 of such a distributed system.

In one embodiment, the performance image 245 is a matrix, where each element corresponds to a real-time services 215. The elements may be seen as corresponding to a characteristic of the image (intensity, color, grey scale, contrast or brightness as stated above). Each time real-time performance data 211 is received, a new image 245 or an instance of the image (in case, time is but one dimension) is generated enabling image analysis over time for detecting trends in the system of real-time services 215.

The inventors have thus provided for an ingenious manner of automatically monitoring large systems of real-time services 215. This based on the brilliant realization to discard traditional diagnostic methods and instead utilize images that are to be analyzed by highly developed image analysis tools 250.

As stated above, the monitoring arrangement may be arranged to train the image analysis tool 250, either through a local training 270 or through a remote training.

The inventors have also realized that since the real-time services 215 generate the performance data 211 resulting in the performance image 245, the resulting image can be controlled to perfection as the values of the real-time performance data 211 and the corresponding characteristics are controlled generated by the monitoring arrangement 100. The corresponding characteristics of the real-time performance data 211 may thus be tuned during training so that an image 245 that is optimum for image analysis (or at least provides the highest confidence result) is produced. If a characteristics setting provides a low success rate in recognizing patterns, the characteristics may be adjusted until a high (enough) success rate is achieved, i.e. a success rate exceeding a wanted success ratio. The manner of adjusting the characteristics, depend on the current image analysis tool used and details on this will not be given herein as that would render this text illegible.

The training 270 is therefore, in one embodiment, also arranged to adapt the characteristics in how they are generated. Factors that can fool or make it harder for the image analysis tool 250 to successively recognize a pattern 255 (such as white balance, focus, and so on) can thus be eliminated or at least significantly reduced.

The inventors have also realized that as the training is not based on real-life, the distribution of different test cases may be controlled so that different use-cases receive equal training, which is a feature that is not available to normal training of image analysis tools.

Furthermore, as the image is of a set size, corresponding to the real-time services 215, and as the real-time performance data is received in a simplified form, or at least converted into a simplified form after reception by the monitoring arrangement 100, the amount of data to be stored only corresponds to the image and the requirements for data storage are thus greatly relaxed compared to contemporary monitoring systems.

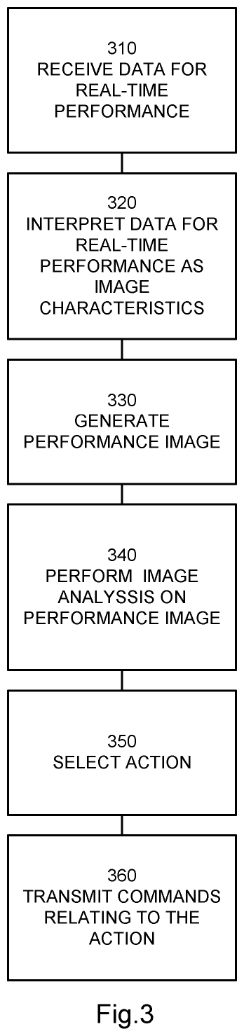

FIG. 3 shows a flowchart of a general method according to an embodiment of the teachings herein. The method utilizes a software monitoring of real-time services arrangement 100 as taught herein. The software monitoring of real-time services arrangement 100 receives 310 the real-time performance data 211 from the real-time services 215. The real-time performance data 211 is received in or transformed into a simplified form, indicating and interpreted 320 as a characteristic of an area corresponding to the real-time services 215 of the real-time performance data 211 as a performance image 245 is generated 330 representing the performance of the system of real-time services 215. Image analysis is performed 340 on the performance image 245, to detect a pattern 255. Based on the detected pattern 255, an associated action is selected 350 and commands relating to the action is transmitted 360 to the real-time services 215 for controlling the real-time services 215 to avoid an error situation or to achieve a desired result (possibly being to avoid the error situation). The commands may be transmitted to the real-time services 215 or to another device for example to issue an alert or a warning in case it is determined that no suitable course of action is possible for achieving the desired result.

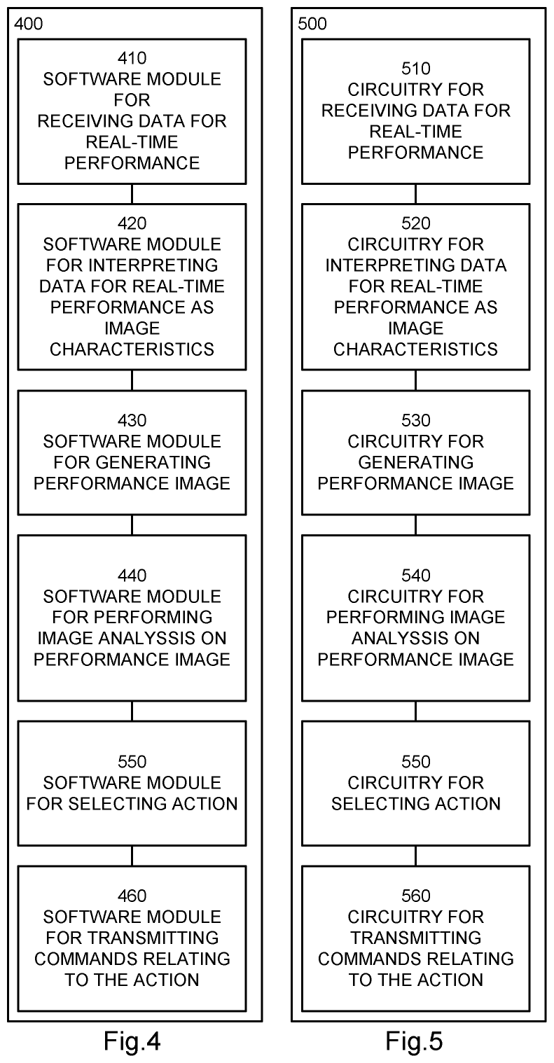

FIG. 4 shows a component view for a software component (or module) arrangement 400 according to an embodiment of the teachings herein. The software component arrangement 400 is adapted to be used in a software monitoring of real-time services arrangement 100 as taught herein for automated software monitoring of real-time services as taught herein.

The software component arrangement 400 comprises a software component for receiving 410 data relating to real-time performance 211 from one or more real-time services 215, the data relating to real-time performance 211 indicates a performance of the real-time services 215;

The software component arrangement 400 also comprises a software component for generating 430 a performance image 245 wherein the data relating to real-time performance 211 for an associated real-time services 215 indicates an image characteristic in an area of the performance image 245 corresponding to the associated real-time services 215, a software component for performing 440 image analysis 250 on the performance image 245, and a software component for selecting 450 an action for achieving a desired result based on the image analysis.

FIG. 5 shows a component view for an arrangement comprising circuitry for software monitoring of real-time services 500 according to an embodiment of the teachings herein. The arrangement comprising circuitry for software monitoring of real-time services 500 is adapted to be used in a software monitoring of real-time services arrangement 100 as taught herein for software monitoring of real-time services.

The arrangement comprising circuitry for software monitoring of real-time services 500 of FIG. 5 comprises circuitry for receiving 510 data relating to real-time performance 211 from one or more real-time services 215, the data relating to real-time performance 211 indicates a performance of the real-time services 215.

The arrangement comprising circuitry for automated software monitoring of real-time services 500 also comprises circuitry for generating 530 a performance image 245 wherein the data relating to real-time performance 211 for an associated real-time services 215 indicates an image characteristic in an area of the performance image 245 corresponding to the associated real-time services 215, circuitry for performing 540 image analysis 250 on the performance image 245, and circuitry for selecting 550 an action for achieving a desired result based on the image analysis.

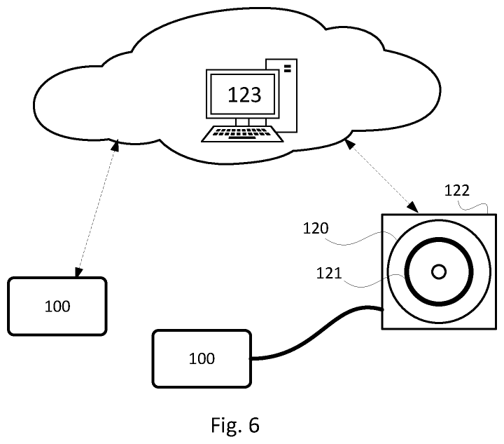

FIG. 6 shows a schematic view of a computer-readable medium 120 carrying computer instructions 121 that when loaded into and executed by a controller of a software monitoring of real-time services arrangement 100 enables the software monitoring of real-time services arrangement 100 to implement the present invention.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 6, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the software monitoring of real-time services arrangement 100 for being executed by the controller 101.

The computer disc reader 122 may also or alternatively be connected to (or possibly inserted into) a software monitoring of real-time services arrangement 100 for transferring the computer-readable computer instructions 121 to a controller of the software monitoring of real-time services arrangement (presumably via a memory of the software monitoring of real-time services arrangement 100).

FIG. 6 shows both the situation when a software monitoring of real-time services arrangement 100 receives the computer-readable computer instructions 121 via a wireless server connection (non-tangible) and the situation when another software monitoring of real-time services arrangement 100 receives the computer-readable computer instructions 121 through a wired interface (tangible). This enables for computer-readable computer instructions 121 being downloaded into a software monitoring of real-time services arrangement 100 thereby enabling the software monitoring of real-time services arrangement 100 to operate according to and implement the invention as disclosed herein.

It would be realized by a skilled person taking part of the teachings herein that the real-time services will operate to survey each other, leading to a more robust surveillance system. The interconnection between the real-time services and the reporting of real-time performance also provide for an indirect reporting of performance of interconnected real-time services. this way, even if there should temporarily be a lost signal from a first service, it would be possible to infer its data from other services.

There is no need to create a mechanistic model from low-level metrics (e.g., CPU usage, memory, disk etc.) to functional-level events, such as violations of real-time requirements in a service which lifts the burden from the real-time service developers to develop such models. The experts of each real-time service only needs to implement the low-level mechanisms for computing real-time performance and for implementing actions to increase/decrease these, which is a significant save in developing costs. This gives the system the flexibility of allowing different types of real-time services to compute their real-time performance through different methods as well as to use different mechanisms to increase/decrease the real-time performance. This eliminates the need for a developing a silver bullet that fits all real-time services.

Also, the monitoring arrangement 100 will automatically detect and learn that a change in real-time performance of a first service may cause different effects in the network of real-time services 215 than a change in performance for another real-time service.

The monitoring arrangement 100 is also enabled to automatically capture the underlying mechanisms and the correlations to other services (e.g., an increase of real-time performance of a first service often causes an increase in real-time performance of a second service).

The monitoring arrangement 100 is also enabled to detect when a new patch to a service leads to unexpected performance of other services in the network. This will increase the efficiency/cost ration for monitoring the system, since it reduces the number of humans having a complete understanding of the entire system. The proposed invention can therefore help to pin-point and locate any software/hardware issues.

The proposed solution scales well, since the amount of data collected from the real-time services may be done through a standardized API and the cost for which is low.

Another benefit by using the deep CNN and arranging the collected real-time performance data as an image, is that the technology can be future-proof and ensure that it will be possible to utilize the future advancements in the field of image recognition and machine learning.

1. A software monitoring of real-time services arrangement comprising a controller configured to:
receive data relating to real-time performance from one or more real-time services, the data relating to real-time performance indicates a performance of the real-time services;
generate a performance image wherein the data relating to real-time performance for an associated real-time services indicates an image characteristic in an area of the performance image corresponding to the associated real-time services;
perform image analysis on the performance image; and
select an action for achieving a desired result based on the image analysis.

2. The software monitoring of real-time services arrangement according to claim 1, wherein the image analysis tool is based on a neural network.

3. The software monitoring of real-time services arrangement according to claim 2, wherein the controller is further configured to train the image analysis.

4. The software monitoring of real-time services arrangement according to claim 1, wherein the controller is further configured to transmit one or more commands to one or more of the real-time services, wherein the one or more commands relate to the selected action and wherein the one or more commands provides the action when executed by the one or more of the real-time services.

5. The software monitoring of real-time services arrangement according to claim 1, wherein the performance image is a series of images thereby providing an image analysis over time.

6. The software monitoring of real-time services arrangement according to claim 1, wherein the performance image comprises a dimension representing time thereby providing an image analysis over time.

7. The software monitoring of real-time services arrangement according to claim 1, wherein the controller is further configured to receive the data relating to real-time performance in a simplified form, whereby the simplified form is a uniform representation of performance for all real-time services.

8. The software monitoring of real-time services arrangement according to claim 1, wherein the controller is further configured to
perform image analysis on the performance image to detect a pattern, wherein
the action for achieving a desired result based on the image analysis is associated with the detected pattern.

9. The software monitoring of real-time services arrangement according to claim 1, wherein the image analysis is based on object detection for detecting the pattern.

10. The software monitoring of real-time services arrangement according to claim 9, wherein the image analysis tool is based on a neural network and wherein the object detection is based on a Deep Neural Network model.

11. The software monitoring of real-time services arrangement according to claim 1 wherein the controller is further configured to receive the data relating to real-time performance through a message communication bus.

12. A method for automated software monitoring of real-time services in a software monitoring of real-time services arrangement, wherein the method comprises:
receiving data relating to real-time performance from one or more real-time services, the data relating to real-time performance indicates a performance of the real-time services;
generating a performance image wherein the data relating to real-time performance for an associated real-time services indicates an image characteristic in an area of the performance image corresponding to the associated real-time services;
performing image analysis on the performance image; and
selecting an action for achieving a desired result based on the image analysis.

13. A computer-readable medium carrying computer instructions that when loaded into and executed by a controller of a software monitoring of real-time services arrangement enables the software monitoring of real-time services arrangement to implement the method according to claim 12.

14. A software component arrangement for automated software monitoring of real-time services in a software monitoring of real-time services arrangement, wherein the software component arrangement comprises:
a software component for receiving data relating to real-time performance from one or more real-time services, the data relating to real-time performance indicates a performance of the real-time services;
a software component for generating a performance image wherein the data relating to real-time performance for an associated real-time services indicates an image characteristic in an area of the performance image corresponding to the associated real-time services;
a software component for performing image analysis on the performance image; and
a software component for selecting an action for achieving a desired result based on the image analysis.

15. A software monitoring of real-time services arrangement comprising circuitry for automated software monitoring of real-time services comprising:
circuitry for receiving data relating to real-time performance from one or more real-time services, the data relating to real-time performance indicates a performance of the real-time services;
circuitry for generating a performance image wherein the data relating to real-time performance for an associated real-time services indicates an image characteristic in an area of the performance image corresponding to the associated real-time services;
circuitry for performing image analysis on the performance image; and
circuitry for selecting an action for achieving a desired result based on the image analysis.
